(19) United States
(12) Patent Application Publication
(10) Pub. No.: US 2013/0080069 A1
(43) Pub. Date: Mar. 28, 2013

(54) Method to Estimate Likelihood of Pathogenicity of Synonymous and Non-coding Variants Across a Genome

(71) Applicants: Sergio Pablo Sánchez Cordero, Mexico City (MX); Matthew Wheeler, Sunnyvale, CA (US); Euan Ashley, Menlo Park, CA (US)

(72) Inventors: Sergio Pablo Sánchez Cordero, Mexico City (MX); Matthew Wheeler, Sunnyvale, CA (US); Euan Ashley, Menlo Park, CA (US)

(73) Assignee: The Board of Trustees of the Leland Stanford Junior University, Palo Alto, CA (US)

(21) Appl. No.: 13/486,462

(22) Filed: Jun. 1, 2012

Related U.S. Application Data
(60) Provisional application No. 61/491,901, filed on Jun. 1, 2011.

(51) Int. Cl. G06F 19/16

(52) U.S. Cl. CPC G06F 19/16
USPC 702/19

(57) ABSTRACT

A method according to an embodiment of the present invention determines putative changes in splicing, mRNA structure, and protein synthesis. For each of these concepts, scoring algorithms are disclosed that can be used in a genome-wide scale. The described methods provide a pipeline that can be used to analyze the biological effects of SNPs generally, both synonymous and non-synonymous.

### CROSS-REFERENCE TO RELATED APPLICATIONS

This application claims priority to U.S. Provisional Application No. 61/491,901 filed Jun. 1, 2011, which is hereby incorporated by reference in its entirety for all purposes.

### STATEMENT OF GOVERNMENT SPONSORED SUPPORT

This invention was made with Government support under contracts HL083914 and OD004613 awarded by the National Institutes of Health. The Government has certain rights in this invention.

### FIELD OF THE INVENTION

The present invention generally relates to the field of computer diagnostics. More particularly, the present invention relates to methods for analyzing single nucleotide polymorphisms.

### BACKGROUND OF THE INVENTION

Single nucleotide polymorphisms (SNPs) account in significant measure for the genetic variability among individuals. Their importance in linking genotype and phenotype has been recognized in recent years by the emergence of genome wide associations studies (GWAS) and the HapMap project. For example, when they occur in a coding region, SNPs can alter the amino-acid conformation of the encoded protein and modify protein structure and function. In this case, the SNP is said to be non-synonymous given its direct effect on protein conformation.

Several algorithms, such as SIFT and Polyphen, have been created in order to measure the effects of non-synonymous SNPs and have become part of exploring the influence of an SNP on an individual's phenotype. SNPs can also take a more silent role. Due to simple combinatorics, there can be more than one codon coding for a particular amino-acid. SNPs that change a base triplet to another that translate into the same amino-acid are denominated synonymous SNPs (sSNPs). These genetic variations have long been thought to be silent, with no phenotypic effects. Consequently, their evolution pattern was linked to Kimura's neutral theory (N. G. C. Smith and L. D. Hurst: The causes of synonymous rate variation in the rodent genome: can substitution rates be used to estimate the sex bias in mutation rate? Genetics 1999; 152: 661-673; these and all other references cited herein are incorporated by reference for all purposes), that states that some mutations occur by chance alone since there is no natural selection to guide them.

In recent years there has been an accumulation of evidence showing synonymous mutations are not as silent as expected. Work done in Smith et al. and Akashi et al. confirms correlations between nucleotide content in synonymous sites and nucleotide conformation of flanking isochores (non-coding DNA rich in GC content) (N. G. C. Smith and L. D. Hurst: The causes of synonymous rate variation in the rodent genome: can substitution rates be used to estimate the sex bias in mutation rate? Genetics 1999; 152: 661-673; H. Akashi and A. Eyre-Walker: Translational selection and molecular evolution. Curr. Opin. Genet. Dev. 1998; 8: 688-693). Codon usage bias has also been demonstrated to be linked with synonymous mutations (T. Ikemura: Codon usage and tRNA content in unicellular and multicellular organisms. Mol. Biol. Evol. 1985 2: 13-34) and their evolution, as in the case of the isochores, is most likely non-neutral (H. Akashi and A. Eyre-Walker: Translational selection and molecular evolution. Curr. Opin. Genet. Dev. 1998; 8: 688-693). This provides an evolutionary framework for sSNPs, in which selection forces influence such mutations by constraining surrounding sequences that are neither gene nor exon specific. Evidence of the an sSNP's power to alter the phenotype has been the work done by Kimchy et al. (Kimchi-Sarfaty et al.: A “Silent” Polymorphism in the MDR1 Gene Changes Substrate Specificity Science 2007; V 315 No 5811: 525-528), where the authors demonstrate how certain haplotypes, consisting solely of synonymous SNPs in the MDR1 gene, alter the protein structure and function of the P-glycoprotein pump. This in turn reduces the efficacy of chemotherapy treatments, revealing important clinical implications.

### SUMMARY OF THE INVENTION

In an embodiment of the present invention, sSNPs are taken into account when linking genotype to phenotype, either through evolutionary studies or in determining risks for disease. Complete genome sequences of individuals, families, or populations contain thousands to millions of sequence variants that do not cause direct changes in protein coding through canonical codon-amino acid changes. Analysis of whole genomic data in a comprehensive manner requires development and utilization of tools which provide relevant information about DNA perturbations (single nucleotide variants, insertions-deletions, structural variants) that may affect biological function of the organism. In particular, methods that select and identify particular variants that are predicted to perturb RNA, whether production, stability, or interaction with other molecules in the cell and organism to alter RNA or DNA structure and to modify RNA-RNA, RNA-protein, or RNA-DNA interactions are needed to provide further targets for investigation, to uncover risk for disease, and to determine alterations to pharmacokinetic and pharmacodynamic response to therapy.

Disclosed herein are methods and processes to analyze genomic variant data to characterize in a comprehensive manner variants that may perturb RNA processing, interactions, trafficking, and degradation. Among other things, a prioritization schema is disclosed that allows identification of variants most likely to affect function and identify targets of interest. The present invention includes methods and processes to validate in silico findings through in vitro analyses.

In the present disclosure, an embodiment of the present invention is disclosed as a pipeline of computational methods that analyze biologically sensible venues that sSNPs can take to alter protein function. The methods of the present invention are also applicable to non-synonymous SNPs and can be used to give biological explanations to correlations between SNPs and diseases.

The methods of the present invention explore some of the biological paths that a nucleotide variant, regardless of its context (coding or non-coding) can take to have a tangible effect in gene regulation, RNA stability, or protein binding and function. The disclosed methods include methods for determining putative changes in splicing, RNA structure, and protein synthesis. For each of these concepts, scoring algorithms are proposed that can be used efficiently in a genome-wide scale.

An application of the present invention includes prioritizing variants found in any genomic o transcriptomic dataset. It is useful as a tool to discover potential genomic or genetic explanations of disease, pharmacologic response, and phenotype alterations. Another application includes the identification of novel drug targets. The methods of the present invention deal with these variants in an automatic, computational manner, and can be used in a genome-wide scale. A modular approach of the present invention allows the methods to switch between core components, including using different splice site detection algorithms, structure prediction methods, among other things. The methods of the present invention can be trained using sufficient data to adjust its parameters or evaluate its performance.

Among other things, embodiments of the present invention include the following advantages:
Genomic scale of synonymous and non-coding variant analysis;
Integration of techniques with other methods;
Computationally tractable methods of large scale structural analysis;
Integration of multiple independent algorithms into a bundled analysis
Prioritization schema to allow scoring and identification of high probability variants for further study;
Training of schema using multiple genome-scale datasets, among other advantages;
Able to identify missed opportunities in pharmacogenetic or genome-wide association analyses;
Many fold reduction of potential targets; and
Able to integrate training sets for dedicated purposes.

Using the methods of the present invention, at least two classes of commercial problems are addressed:
a. Families or individuals that have been genotyped in a genomic scale that seek interpretation of their data.
b. Biotechnology and pharmaceutical companies that seek to leverage genomic datasets for drug discovery, repurposing, and pharmacogenetic analysis.

These and other embodiments and advantages can be more fully appreciated upon an understanding of the detailed description of the invention as disclosed below in conjunction with the attached Figures.

### BRIEF DESCRIPTION OF THE DRAWINGS

The following drawings will be used to more fully describe embodiments of the present invention.

FIG. 1 is a block diagram of a computer system on which the present invention can be implemented.

FIG. 2 is a flowchart of a method according to an embodiment of the present invention.

FIG. 3 is a graph that shows P0 5′ splice sites where reference scores and SNP-modified scores are shown with lines joining the two scores for each SNP and where the X-axis is chromosome position and the Y-axis is score according to an embodiment of the present invention.

FIG. 4 is a another graph that shows P0 3′ splice sites according to an embodiment of the present invention.

FIG. 5 is a graph that shows P0 mRNA structure Z-scores according to an embodiment of the present invention.

FIG. 6 is a graph that shows Saqqaq 5′ splice sites according to an embodiment of the present invention.

FIG. 7 is a graph that shows Saqqaq 3′ splice sites according to an embodiment of the present invention.

FIG. 8 is a graph that shows Saqqaq mRNA structure Z-scores according to an embodiment of the present invention.

FIG. 9 (Table 1) is a table of GWAS catalog codon usage analysis top hits.

FIG. 10 (Table 2) is a table of GWAS catalog mRNA structure top hits.

FIG. 11 (Table 3) is a table of GWAS catalog 3′ acceptor splice sites top hits.

FIG. 12 is a flowchart of a method according to an embodiment of the present invention.

### DETAILED DESCRIPTION OF THE INVENTION

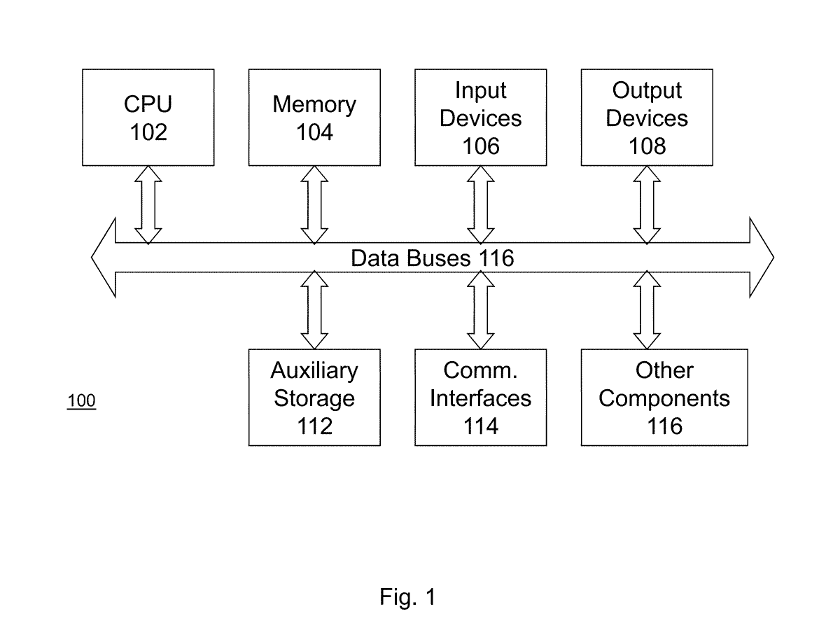

Among other things, the present invention relates to methods, techniques, and algorithms that are intended to be implemented in a digital computer system 100 such as generally shown in FIG. 1. Such a digital computer is well-known in the art and may include the following.

Computer system 100 may include at least one central processing unit 102 but may include many processors or processing cores. Computer system 100 may further include memory 104 in different forms such as RAM, ROM, hard disk, optical drives, and removable drives that may further include drive controllers and other hardware. Auxiliary storage 112 may also be include that can be similar to memory 104 but may be more remotely incorporated such as in a distributed computer system with distributed memory capabilities.

Computer system 100 may further include at least one output device 108 such as a display unit, video hardware, or other peripherals (e.g., printer). At least one input device 106 may also be included in computer system 100 that may include a pointing device (e.g., mouse), a text input device (e.g., keyboard), or touch screen.

Communications interfaces 114 also form an important aspect of computer system 100 especially where computer system 100 is deployed as a distributed computer system. Computer interfaces 114 may include LAN network adapters, WAN network adapters, wireless interfaces, Bluetooth interfaces, modems and other networking interfaces as currently available and as may be developed in the future.

Computer system 100 may further include other components 116 that may be generally available components as well as specially developed components for implementation of the present invention. Importantly, computer system 100 incorporates various data buses 116 that are intended to allow for communication of the various components of computer system 100. Data buses 116 include, for example, input/output buses and bus controllers.

Indeed, the present invention is not limited to computer system 100 as known at the time of the invention. Instead, the present invention is intended to be deployed in future computer systems with more advanced technology that can make use of all aspects of the present invention. It is expected that computer technology will continue to advance but one of ordinary skill in the art will be able to take the present disclosure and implement the described teachings on the more advanced computers or other digital devices such as mobile telephones or “smart” televisions as they become available. Moreover, the present invention may be implemented on one or more distributed computers. Still further, the present invention may be implemented in various types of software languages including C, C++, and others. Also, one of ordinary skill in the art is familiar with compiling software source code into executable software that may be stored in various forms and in various media (e.g., magnetic, optical, solid state, etc.). One of ordinary skill in the art is familiar with the use of computers and software languages and, with an understanding of the present disclosure, will be able to implement the present teachings for use on a wide variety of computers.

The present disclosure provides a detailed explanation of the present invention with detailed explanations that allow one of ordinary skill in the art to implement the present invention into a computerized method. Certain of these and other details are not included in the present disclosure so as not to detract from the teachings presented herein but it is understood that one of ordinary skill in the art would be familiar with such details.

Among other things, the present invention serves to identify variations in large scale genomic or transcriptomic datasets that cause significant alterations in RNA or DNA function through mechanisms independent of changes in amino acid coding. The method and process of the present invention allow for the prioritization of genome-scale variants for validation, modification, treatment, or development of therapeutic targets.

Methods

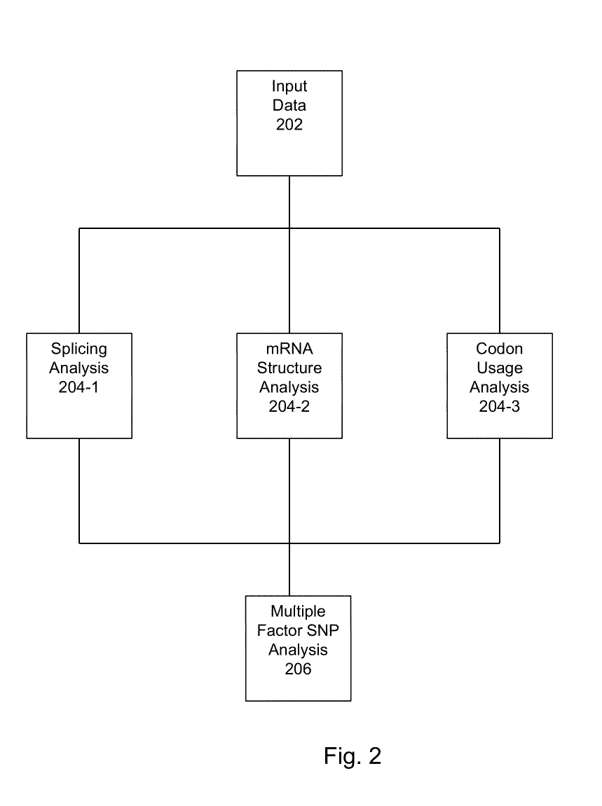

Apart from amino-acid substitutions, there can be other ways that polymorphisms can affect a gene and its resulting protein products. Shown in FIG. 2 is a method according to an embodiment of the present invention for analyzing the manner in which polymorphisms can affect a gene and its resulting protein products. Shown at step 202 is the input of the data to be used in the present analysis. Such data can be in different forms as will be discussed below. In a first analysis of a multifactor pipeline analysis of the present invention, a splicing analysis is performed at step 204-1. For example, alteration of splice sites can modify how a gene is spliced and result in important changes in the resulting mRNAs, most of them ending in premature mRNA degradation. Creation of spurious splice sites can also occur, and can be just as disruptive to the resulting protein. These and other such issues are analyzed in step 204-1.

Other factors that affect protein production and structure include mRNA decay rates and mRNA structural motifs surrounding important regulatory sites (such as 5′ and 3′ UTRs) which are analyzed at step 204-2.

At step 204-3 a codon usage analysis is performed. Codon usage bias can have a direct effect on protein elongation and translational kinetics, a consequence of the correlation between codon usage frequency and tRNA availability. (It is important to note that such correlation has been found in fast-growth organisms, such as E. coli but no study has systematically analyzed such relation in humans).

In this embodiment of the present invention, three mechanisms are considered to detect putative phenotypic changes provoked by sSNPs at steps 204-1, -2, and -03. The pipelined approach of the present invention further allows for a combined analysis of two or more of the separate SNP analyses (e.g., 204-1, -2, and -03) at step 206. For example, the results of the splicing analysis of step 204-1 can supplement one or both of the mRNA structure analysis (step 204-2) and codon usage analysis (step 204-3). In an embodiment, for example, where machine learning methods are implemented, the multiple factor SNP analysis of step 206 can be used to improve or speed up the learning process. In another embodiment, the separate results can be used to cross-check or buttress the individual analysis results.

To be described further below are further details of the embodiment shown in FIG. 2.

Splicing

Aberrant splicing is a phenomenon that has been linked to synonymous mutations in various studies. Creation and disruption of 5′ donor splice sites and exonic splice site enhancers through synonymous alterations have been reported to be part of the etiology of diseases such as type 1 neurofibromatosis, multiple sclerosis, and phenylketonuria (J. V. Chamary, Joanna L. Parmley and Laurence D. Hurst: Hearing silence: non-neutral evolution at synonymous sites in mammals Nature Reviews Genetics 2006; 7: 98-108). Splice site prediction algorithms used for genome-wide gene detection can also be used to detect putative disruption or creation of splicing sites, for example, by comparing predictions when applying the algorithm to reference and the variant DNA sequences.

Using these criteria in an embodiment of the invention, the maximum entropy splice site detection algorithm (G. Yeo, C. B. Burge: Maximum Entropy Modeling of Short Sequence Motifs with Applications to RNA Splicing Signals J. of Comp. Biology 2004, 11(2-3): 377-394) is applied to the flanking sequence of an SNP with and without the polymorphic substitution. Predictions resulting in a positive odds ratio for the reference sequence but in a negative odds ratio for the sequence with the polymorphism are flagged as putative splice site disruptions. Changes in the other direction, where a negative prediction would be given for the reference sequence, but a positive score would be assigned to the SNP-affected sequence, are reported as putative creation of splice sites.

mRNA Structure

Several factors surrounding mRNA structure are associated with important effects on phenotype. It directly affects mRNA decay rates as well as conferring protection from premature degradation. Furthermore, highly structured UTRs can prevent regulatory molecules, such as microRNAs, to fulfill their role. Investigating the effects of SNPs in mRNA structure becomes a pivotal point to indirectly study putative changes in the resulting protein. Articles have already laid ground on the case by analyzing the influence of sSNPs in mRNA secondary structure and its effects on mRNA stability and decay (J. V. Chamary, Joanna L. Parmley and Laurence D. Hurst: Hearing silence: non-neutral evolution at synonymous sites in mammals Nature Reviews Genetics 2006; 7: 98-108). RNA secondary structure prediction is a problem in computational biology and there are methods that give reasonable estimates. Most of them report the resulting free energy, AG, of the predicted secondary structure, giving a thermodynamic measure of structure. Algorithms for detecting non-coding RNAs use free energy along with other heuristics to detect putative biologically active transcripts (E. Rivas and S. Eddy: Secondary structure alone is generally not statistically significant for the detection of noncoding RNAs Bioinformatics 1999; V 16 No 7: 583-605). In particular, these algorithms attempt to find a ‘structural signal’ in a certain window of nucleotides while scanning a genome.

An approach to do this is by performing free energy calculations for randomized samples of the same size and monomeric or dimeric conformations than that of the current window. A Z-score is then given to the window, defined as:

$$Z \text{-} score ( G ; seq ) = \frac{G ( seq ) - {G}_{μ} ( seq , S )}{{G}_{σ} ( seq , S )} \qquad ( 1 )$$

Where G(seq) is the free energy of the RNA sequence seq, G_{μ}(seq, S) is the average free energy of the sequences of the sample set S that have the same length and monomeric (or dimeric, if desired) conformation than seq, and G_{σ}(seq, S) is the standard deviation of the free energies of S.

There has been evidence demonstrating that secondary structure by itself does not give a strong signal from random sequences with the same monomer or even dimer conformations (E. Rivas and S. Eddy: Secondary structure alone is generally not statistically significant for the detection of noncoding RNAs Bioinformatics 1999; V 16 No 7: 583-605). Permutation of nucleotides is a more benign alteration than deletion, insertion, or replacement.

To express this in the Z-score in an embodiment of the invention, the definition of the sample set S is modified to a set of random sequences of the same length of the window but not necessarily with the same n-meric conformation. To apply the Z-score notion to probe if a change in secondary structure occurs with an SNP, the structural significance of the subsequence flanking the SNP was assessed. This was done by taking two windows: the flanking window W_{f} and the sampling window Wₛ. The flanking window is the sequence that contains the SNP position in its midpoint. The sampling window is a subsequence of the flanking window and also contains the SNP position.

Sampling is then performed from the set S(W_{f}, Wₛ) of sequences with length of the flanking window that vary only in the sampling window. Finally, the Z-score, as defined previously, is taken using this sample set:

$$Z \text{-} score ( G ; seq ) = \frac{G ( seq ) - {G}_{μ} ( seq , S ( {W}_{f} , {W}_{s} ) )}{{G}_{σ} ( seq , S ( {W}_{f} , {W}_{s} ) )} \qquad ( 2 )$$

This is done using the ViennRNA folding package. The Z-score of the reference sequence is then compared with the Z-score of the sequence containing the SNP substitution and obtain a ΔΔG score in an embodiment. This score expresses the difference between structural importance of the sequence in the sampling window in the reference and SNP-containing sequence.

Codon Usage

Two genes that code for the same protein using synonymous codons do not necessarily give the same result. This is mainly due to the fact that tRNA iso-acceptors do not have equal abundance in the cell (J. V. Chamary, Joanna L. Parmley and Laurence D. Hurst: Hearing silence: non-neutral evolution at synonymous sites in mammals Nature Reviews Genetics 2006; 7: 98-108). Even though this was confirmed in vitro several years ago, only recently has such a situation been observed in vivo.

The demonstration that codon usage bias can alter translational kinetics opens an interesting new venue to search for relations between phenotype alterations and sSNPs. Codon usage bias analysis has been studied (G. Zhang and Z. Ignatova: Generic Algorithm to Predict the Speed of Translational Elongation: Implications for Protein Biogenesis PLoS ONE 2009; 4: e5036. doi:10.1371/journal.pone.0005036) where several results confirm that, in some organisms, codon usage is also related with position, since it is not rare to see codons with similar relative frequency cluster together in particular sites. (Relative frequency is the frequency of a codon occurring in a genome with respect to codons that code for the same amino-acid. Absolute frequency is the frequency of codon occurrence with respect to the set of all codons.)

This has led to the hypothesis that codon choice is directed by evolution, given that there could be selection constraints acting in aspects of translational kinetics, such as protein elongation. Following this conceptualization, changes in codon bias are assessed via a clustering criterion in an embodiment of the invention. Given an exon sequence, seq, a set of pairs is first produced

Ci(seq)={(nnorm/N,reln)}

for all possible n in seq, where n is the n-th codon in the sequence given the i-th open reading frame, N is the total number of codons in the sequence, and reln is the relative frequency of the n-th codon. The k-means clustering algorithm is then applied to Ci(seq) for each ORF with a given k. This is performed with both the reference and SNP-modified sequence, SNP seq. Finally, for all ORFs, the resulting centroids are compared between both sequences and the sum of their distances is computed, taking the minimum of these values. In other words, the final codon usage score CU is:

$$CU = {min}_{i} \sum dist ( {C}_{k , i} ( seq ) , {C}_{k , i} ( SNP seq ) ) \qquad ( 3 )$$

where C_{k,i} is the set of k centroids in the i-th ORF.

Results

An embodiment of the present invention was tested in two settings: partial genome scans and reported disease polymorphisms. The first setting is for testing the feasibility of using the pipeline as a means to discover putative genotypes that could account for phenotypic differences in individuals while the second is for giving biological interpretations to correlations found between SNPs and diseases. For partial genome scans, SIFT was used to obtain the coding variants of two recently sequenced human genomes: patient zero (P0) (D. Pushkarev, N. F. Neff, and S. R. Quake: Single-molecule sequencing of an individual human genome Nature Biotech. 2009; V 27 No 9: doi:10.1038/nbt.1561) and the ancient human genome (Saqqaq) (M. Rasmussen et al.: Ancient human genome sequence of an extinct Palaeo-EskimoNature 2010; 463: 757-762). For disease polymorphisms, the open access GWAS compilation made in Johnson et al. (A. D. Johnson and C. J. O'Donnell: An Open Access Database of Genome-wide Association Results BMC Medical Genetics 2009; 10:6: doi:10.1186/1471-2350-10-6) was used. Each of the methods described above was run on all SNPs, in each of the data sets with the following parameters:
For the mRNA structure algorithm, the following was used: sample sizes of 700 sequences, a flanking window of 80 nucleotides, and a sampling window of 8.
For the codon usage algorithm, a k of 20 was used.

P0

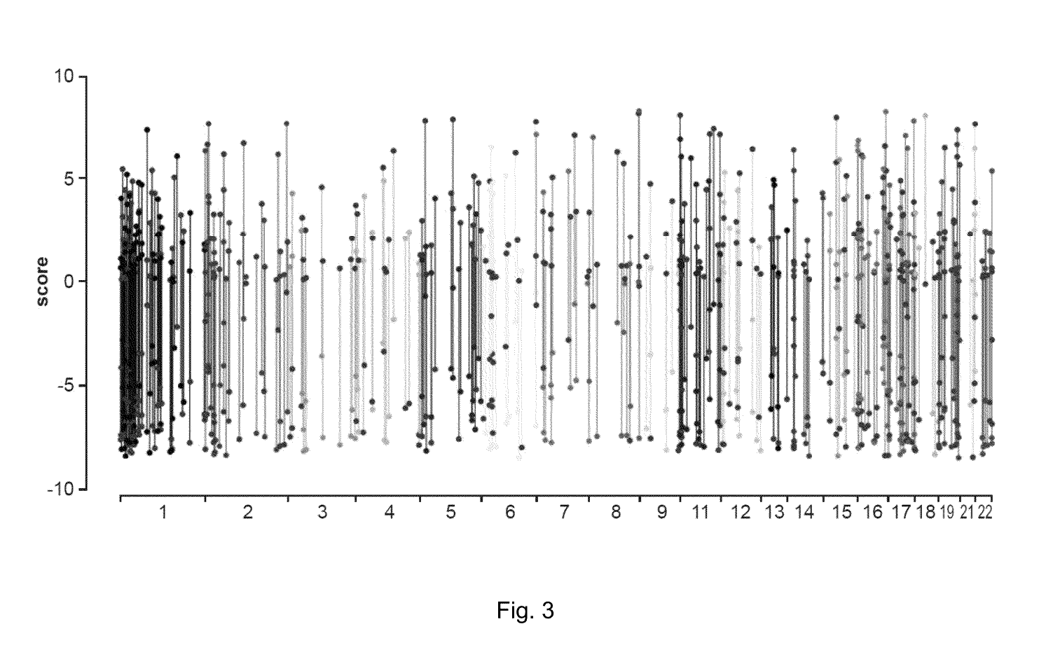

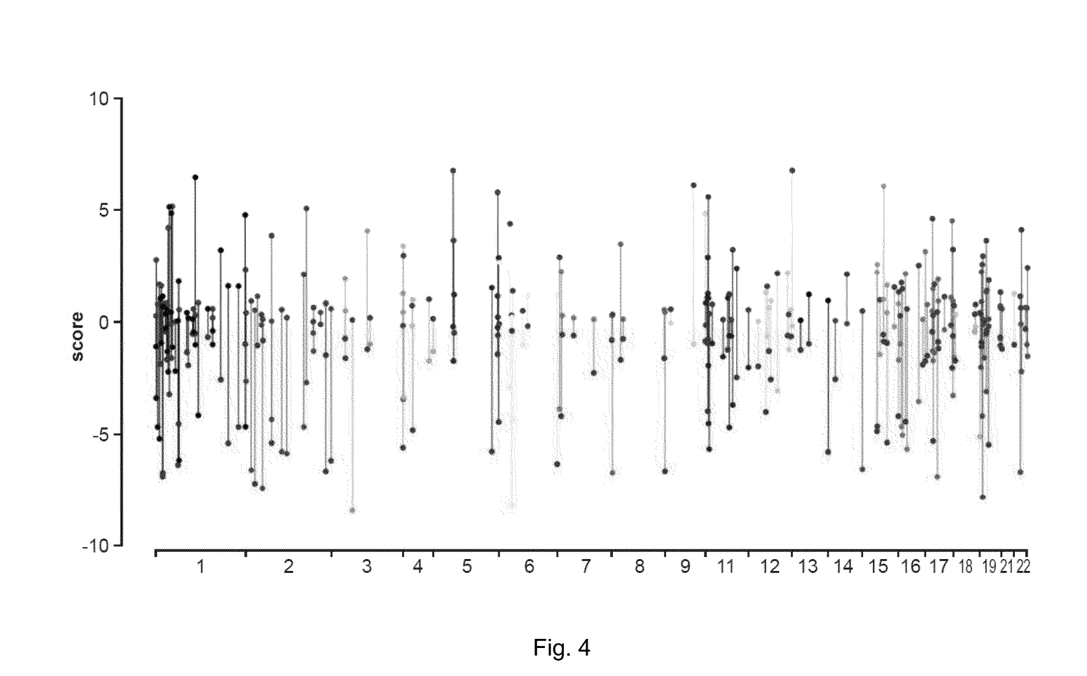

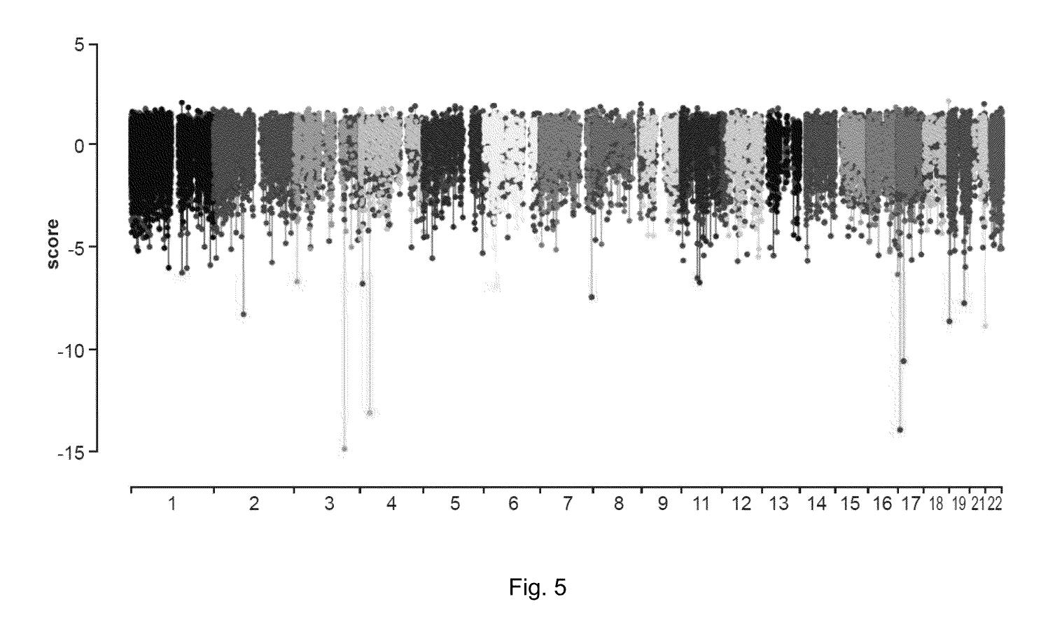

Shown in FIG. 3 is a graph of PO 5′ splice sites. In FIG. 3 are reference scores and SNP-modified scores are shown with lines joining the two scores for each SNP. As shown, in the Figure, the X-axis is chromosome position and the Y-axis is score according to an embodiment of the present invention. Shown in FIG. 4 is a graph of P0 3′ splice sites. Shown in FIG. 5 is a graph of PO mRNA structure Z-scores. From this data, it was observed that P0's most significant mRNA structural change that fell in a known gene was observed in the ALCAM cell adhesion molecule, which has been used as a biomarker for several types of cancer, including pancreatic and breast. There are significant splice site disruptions in the AGRN gene, probably resulting in one of its many isoforms. Codon usage outliers included ASPRV1 (negatively correlated with skin carcinomas), NOM1 (nuclear transport protein), and IARS (a tRNA synthetase).

Saqqaq

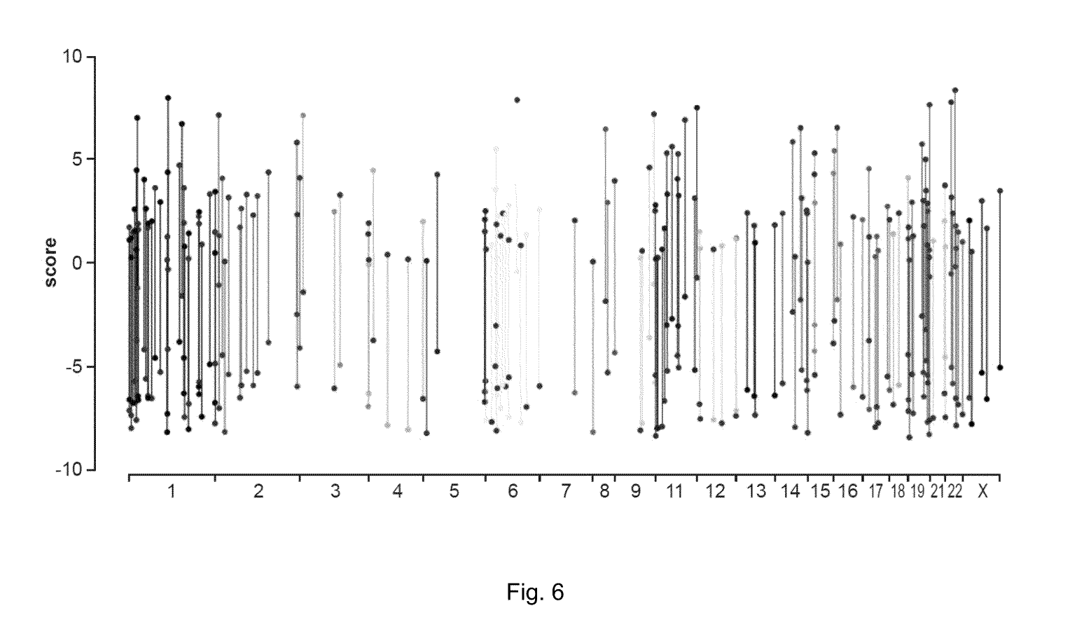

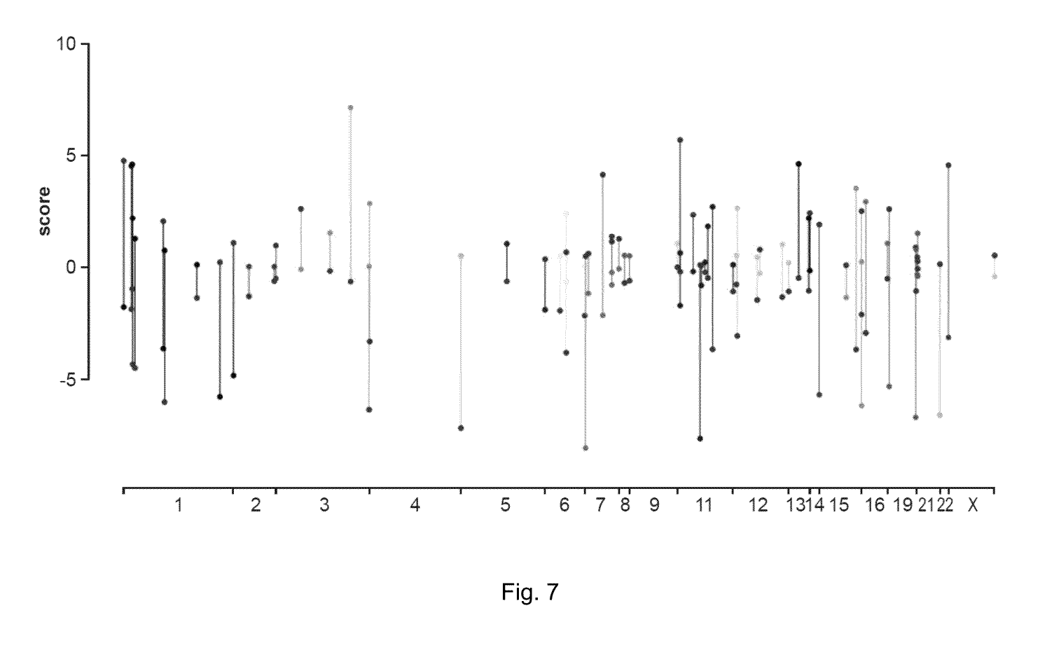

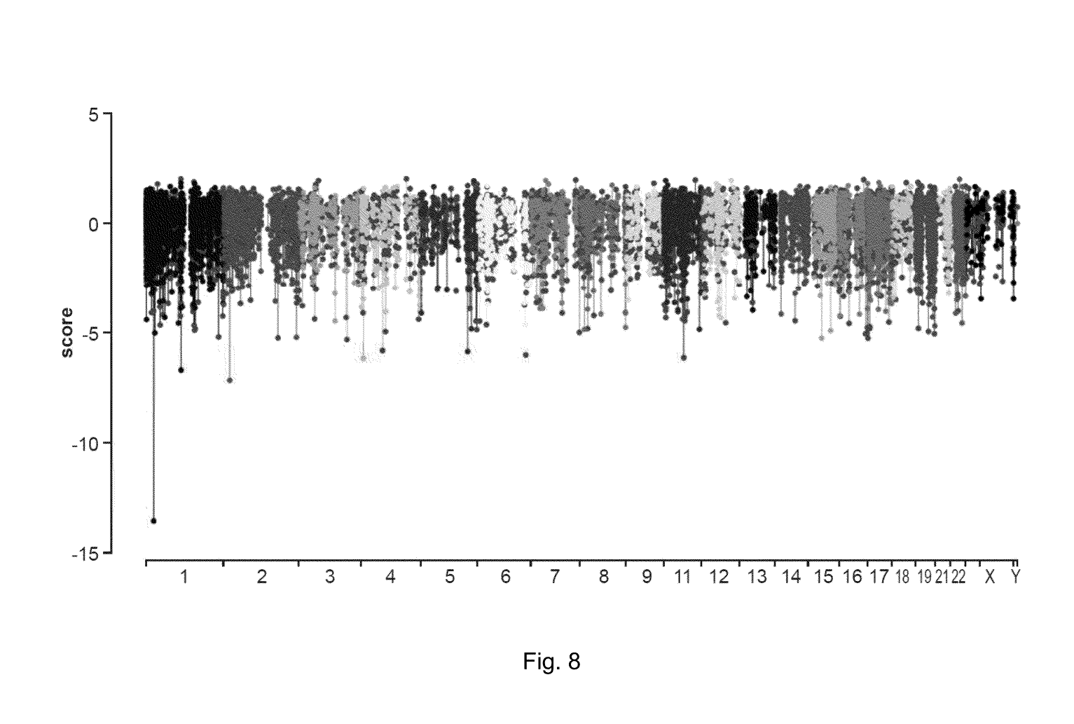

Shown in FIG. 6 is a graph of Saqqaq 5′ splice sites. In FIG. 6 are reference scores and SNP-modified scores are shown with lines joining the two scores for each SNP. As shown, in the Figure, the X-axis is chromosome position and the Y-axis is score according to an embodiment of the present invention. Shown in FIG. 7 is a graph of Saqqaq 3′ splice sites. Shown in FIG. 8 is a graph of Saqqaq mRNA structure Z-scores. From this data, it was observed that Saqqaq has (or rather, had) an unusually tightly structured mRNA for the CRN receptor gene, which is linked to compulsive eating disorders and, to a lesser extent, to squizofrenia. The most significant change in splicing site was a 5′ splice site creation in the NOC2L gene (see FIG. 6), that represses transcription of both p53-dependent reporters and endogenous target genes. Significant change in codon usage distribution was observed in the OR5A1 olfactory receptor and the NXPH4 glycoprotein.

GWAS Catalog

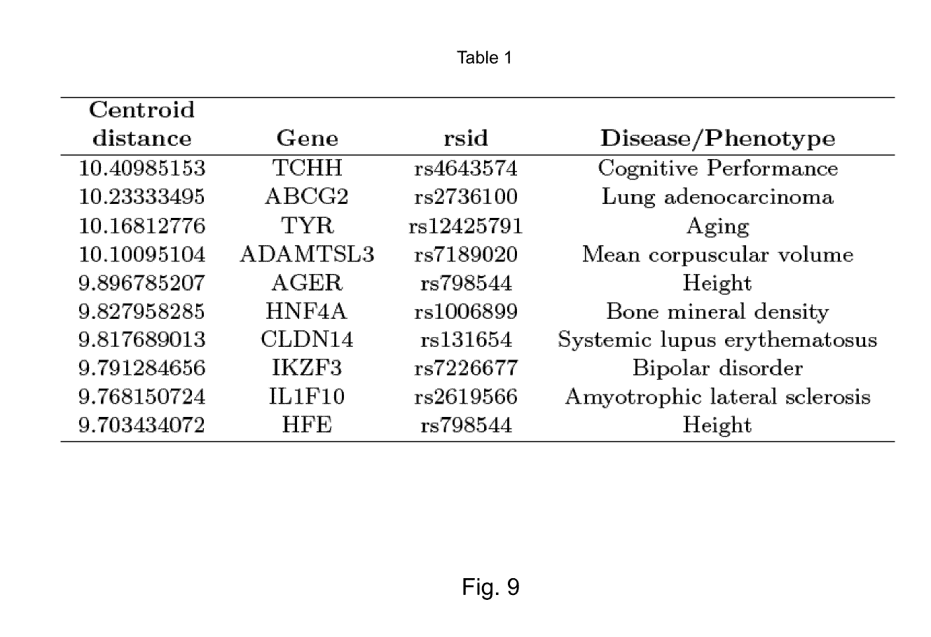

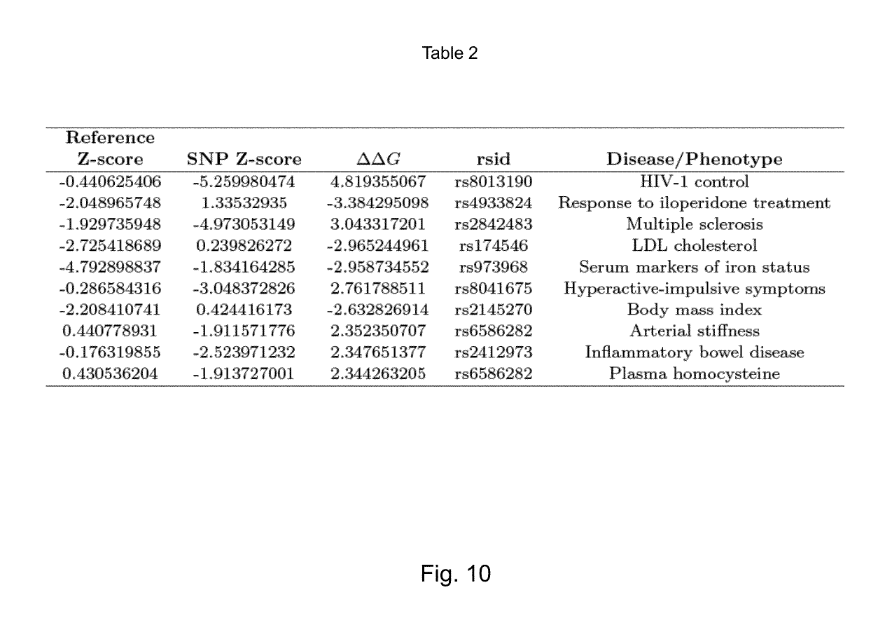

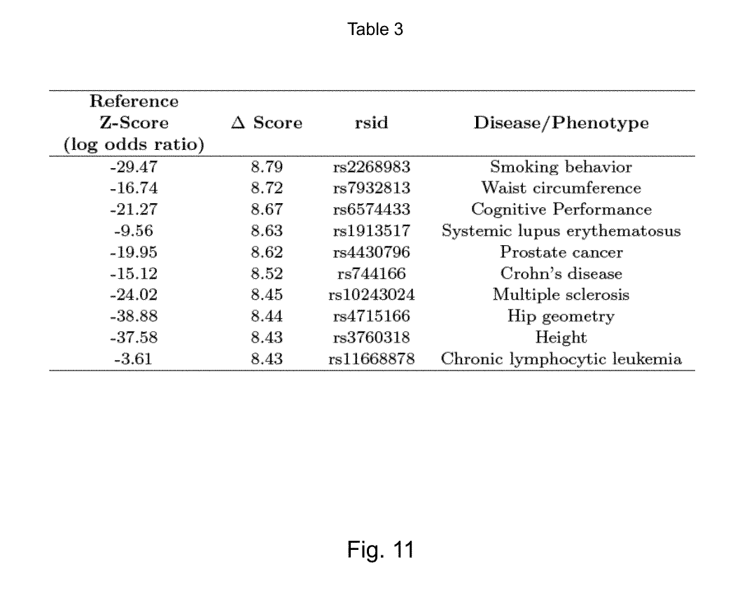

Tables are presented for the top ten hits for each algorithm in the GWAS catalog. Shown in FIG. 9 is Table 1 that is a table of GWAS catalog codon usage analysis top hits. Shown in FIG. 10 is Table 2 that is a table of GWAS catalog mRNA structure top hits. Shown in FIG. 11 is Table 3 that is a table of GWAS catalog 3′ acceptor splice sites top hits. Among other things, some curious coincidences were found. For example, some of the top hits in the codon usage analysis intersect with the top hits in the splicing algorithm. This may hint to a relation between codon usage bias and splicing. Furthermore, diseases such as multiple sclerosis and the family of inflammatory bowel disease (including Crohn's disease) appear as top hits in the three algorithms. Finally, in the coding usage bias, SNPs associated with height appear several times as top hits.

### Discussion and Alternative Embodiments

As an embodiment of the present invention, a computational pipeline has been presented for the analysis of synonymous SNPs. Because of the basic biological principles, the methods described here can also be applied more broadly. For example, in another embodiment, the methods of the present invention can be applied to non-synonymous SNPs, adding biological explanations to their effects on phenotype.

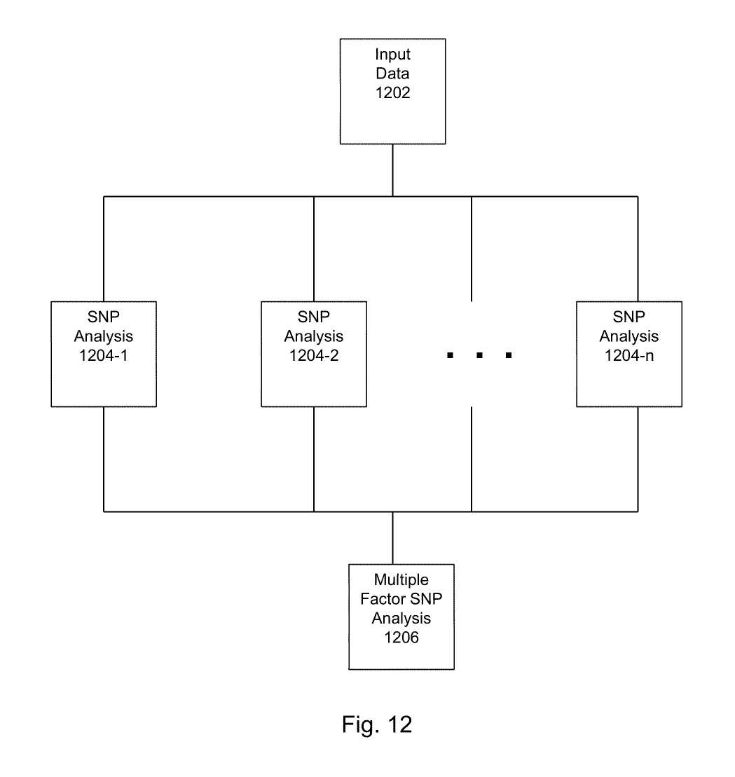

Shown in FIG. 12 is a generalized method according to another embodiment of the present invention for analyzing the manner in which polymorphisms can affect a gene and its resulting protein products. Shown at step 1202 is the input of the data to be used in the present analysis. Such data can be in different forms as discussed herein and as known to those of ordinary skill in the art. In this embodiment of the invention, an n-factor pipeline analysis is implemented (e.g., SNP analysis 1204-1 through SNP analysis 1204-n) as described herein and as would be obvious to those of ordinary skill in the art. The pipelined approach of the present invention further allows for a combined analysis of two or more of the separate SNP analyses (e.g., 1204-1 through 1204-n) at step 1206. Also, in an embodiment, for example, where machine learning methods are implemented, the multiple factor SNP analysis stages can be used to improve or speed up the learning process. In another embodiment, the separate results can be used to cross-check or buttress the individual analysis results.

In another embodiment of the invention, the present invention further allows for a combined analysis of two or more of the separate SNP analyses. For example, the results of the splicing analysis can supplement one or both of the mRNA structure analysis and codon usage analysis. Also, where machine learning methods are implemented, the multiple factor SNP analysis can be used to improve or speed up the learning process. In yet another embodiment, the separate results can be used to cross-check or buttress the individual analysis results. Other applications are also within the scope of the present invention as would be understood by one of ordinary skill in the art.

Embodiments of the methods of the present invention have demonstrated that they are efficient enough to be applied to complete coding regions of whole genomes and are therefore an excellent tool to obtain insights on the biological underpinnings of individual genotypes. an embodiment of the present invention was also used to enrich the biological interpretation of disease-correlated SNPs.

For optimal results, the mRNA structure comparison and the codon usage analysis should preferably be tested in an implementation so as to assure proper operation and correct results. Also, the partial genome scan can be extended to known non-coding RNA genes because the splicing and structure methods focus on the mRNA rather than the protein. The analysis of disease SNPs can be extended to entire haploblocks so as to investigate variations that may account for the disease due to linkage disequilibrium.

Potential applications of the present invention include, but are not limited to:
Personalized genomic/transcriptomic analysis to identify deleterious variants;
Genome wide association studies to identify synonymous and coding variants with functional, nonamino-acid coding related alterations in effect;
Pharmacogenetic analysis to determine variants that may alter target concentrations, stability, or structure; and
Drug discovery to identify novel targets for therapy.
   Many other applications, however, would be obvious to those of ordinary skill in the art.

It should be appreciated by those skilled in the art that the specific embodiments disclosed above may be readily utilized as a basis for modifying or designing other image processing algorithms or systems. It should also be appreciated by those skilled in the art that such modifications do not depart from the scope of the invention as set forth in the appended claims.

What is claimed is:

1. A method for analyzing single nucleotide polymorphisms, comprising:
receiving a first set of subject data;
in a pipelined manner, performing the steps comprising
analyzing splicing of the first set of subject data,
analyzing mRNA structure of the first set of subject data, and
analyzing codon usage for the first set of subject data;
detecting potential phenotypic changes that may have been substantially provoked by single nucleotide polymorphisms.

2. The method of claim 1, wherein analyzing splicing of the first set of subject data, comprises:
applying a maximum entropy splice site detection algorithm to a flanking sequence of a single nucleotide polymorphism in the first set of subject data with a polymorphic substitution;
applying the maximum entropy splice site detection algorithm to a flanking sequence of an SNP in the first set of subject data without a polymorphic substitution;
generating an odds ratio from the results of the detection algorithm;
comparing the subject data to a first set of reference data; and
generating a list of putative splice site disruptions.

3. The method of claim 1, wherein analyzing mRNA structure of the first set of subject data, comprises:
generating a Z-score for the first set of subject data;
generating a Z-score for a first set of reference data;
comparing the Z-score for the subject data with the Z-score for the reference data;
identifying a single nucleotide polymorphism of interest; and
generating a score for the identified single nucleotide polymorphism.

4. The method of claim 1, wherein analyzing codon usage for the first set of subject data, comprises:
generating a codon usage score for the first set of subject data;
generating a codon usage score for a first set of reference data;
comparing the codon usage score for the subject data with the codon usage score for the reference data;
identifying a single nucleotide polymorphism of interest; and
generating a score for the identified single nucleotide polymorphism.

5. The method of claim 1, wherein the pipelined steps are performed substantially independently.

6. The method of claim 1, wherein results from at least two of the pipelined steps are used for a combined analysis.

7. The method of claim 1, wherein generating a score for the identified single nucleotide polymorphism comprises implementing a machine learning algorithm.

8. The method of claim 1, further comprising at least one further pipelined step for analyzing the manner in which polymorphisms may affect a gene and its resulting protein products.

9. The method of claim 1, wherein analyzing splicing of the first set of subject data comprises determining whether alteration of splice sites has occurred in the first set of subject data.

10. The method of claim 1, wherein analyzing mRNA structure of the first set of subject data comprises determining mRNA decay rates in the first set of subject data.

11. A computer-readable medium including instructions that, when executed by a processing unit, cause the processing unit to analyze single nucleotide polymorphisms, by performing the steps of:
receiving a first set of subject data;
in a pipelined manner, performing the steps comprising
analyzing splicing of the first set of subject data,
analyzing mRNA structure of the first set of subject data, and
analyzing codon usage for the first set of subject data;
detecting potential phenotypic changes that may have been substantially provoked by single nucleotide polymorphisms.

12. The computer-readable medium of claim 11, wherein analyzing splicing of the first set of subject data, comprises:
applying a maximum entropy splice site detection algorithm to a flanking sequence of a single nucleotide polymorphism in the first set of subject data with a polymorphic substitution;
applying the maximum entropy splice site detection algorithm to a flanking sequence of an SNP in the first set of subject data without a polymorphic substitution;
generating an odds ratio from the results of the detection algorithm;
comparing the subject data to a first set of reference data; and
generating a list of putative splice site disruptions.

13. The computer-readable medium of claim 11, wherein analyzing mRNA structure of the first set of subject data, comprises:
generating a Z-score for the first set of subject data;
generating a Z-score for a first set of reference data;
comparing the Z-score for the subject data with the Z-score for the reference data;
identifying a single nucleotide polymorphism of interest; and
generating a score for the identified single nucleotide polymorphism.

14. The computer-readable medium of claim 11, wherein analyzing codon usage for the first set of subject data, comprises:
generating a codon usage score for the first set of subject data;
generating a codon usage score for a first set of reference data;
comparing the codon usage score for the subject data with the codon usage score for the reference data;
identifying a single nucleotide polymorphism of interest; and
generating a score for the identified single nucleotide polymorphism.

15. The computer-readable medium of claim 11, wherein the pipelined steps are performed substantially independently.

16. The computer-readable medium of claim 11, wherein results from at least two of the pipelined steps are used for a combined analysis.

17. The computer-readable medium of claim 11, wherein generating a score for the identified single nucleotide polymorphism comprises implementing a machine learning algorithm.

18. The computer-readable medium of claim 11, further comprising at least one further pipelined step for analyzing the manner in which polymorphisms may affect a gene and its resulting protein products.

19. The computer-readable medium of claim 11, wherein analyzing splicing of the first set of subject data comprises determining whether alteration of splice sites has occurred in the first set of subject data.

20. The computer-readable medium of claim 11, wherein analyzing mRNA structure of the first set of subject data comprises determining mRNA decay rates in the first set of subject data.

21. A computing device comprising:
a data bus;
a memory unit coupled to the data bus;
at least one processing unit coupled to the data bus and configured to receive a first set of subject data;
in a pipelined manner, configured to perform the steps comprising
analyze splicing of the first set of subject data,
analyze mRNA structure of the first set of subject data, and
analyze codon usage for the first set of subject data;
detect potential phenotypic changes that may have been substantially provoked by single nucleotide polymorphisms.
